(19) United States
(12) Patent Application Publication
(10) Pub. No.: US 2025/0265874 A1
(43) Pub. Date: Aug. 21, 2025

(54) SYSTEMS AND METHODS FOR UTILIZING VEHICLE DIAGNOSTICS FOR SIGNAL ABSTRACTION

(71) Applicant: FCA US LLC, Auburn Hills, MI (US)

(72) Inventors: Andrew Hoin, Auburn Hills, MI (US); Thomas E Apczynski, Livonia, MI (US); Raghuvirsinh Sodha, Troy, MI (US)

(21) Appl. No.: 18/581,938

(22) Filed: Feb. 20, 2024

(51) Int. Cl. G07C 5/08; H04L 12/40

(52) U.S. Cl. CPC G07C 5/0816; G07C 5/0808; H04L 12/40; H04L 2012/40215; H04L 2012/40273

(57) ABSTRACT

A controller area network (CAN) diagnostic system for a vehicle includes a plurality of electronic control units (ECUs) of the vehicle that are connected to a high-speed CAN of the vehicle and a dedicated control module of the vehicle that is connected to the CAN and that includes an embedded software application configured to receive a diagnostic request for diagnostic data, in response to receiving the diagnostic request, obtain the diagnostic data by at least one of (i) issuing a request to any of the plurality of ECUs for any specific data available from any of the plurality of ECUs and (ii) interpreting raw data pushed onto the CAN by any of the plurality of ECUs, and generate and output a standardized output based on the obtained diagnostic data.

### FIELD

The present application generally relates to vehicle controller area network (CAN) diagnostics and, more particularly, systems and methods for utilizing vehicle CAN diagnostics for signal abstraction.

### BACKGROUND

Today's vehicles have an increasing number of electronic control units (ECUs) and associated sensors that monitor a wide array of vehicle operating parameters. These ECUs and other components, such as a centralized software gateway (SGW) module, are connected to and communicate via a controller area network (CAN). Vehicle CAN diagnostics primarily include identifying faults and errors in the network, monitoring system performance and detecting issue(s) before they become critical, troubleshooting, isolating specific problems within the network, and providing real-time data for analysis and decision making. Conventional CAN diagnostics include CAN Unified Diagnostic Services (UDS) and/or CAN Keyword Protocol (KWP), but these protocols were designed for low-speed communication and are bespoken to specific vehicle models, and are therefore limited in terms of speed, flexibility, and scalability. Accordingly, while such conventional vehicle CAN diagnostic systems do work for their intended purpose, there exists an opportunity for improvement in the relevant art.

### SUMMARY

According to one example aspect of the invention, a controller area network (CAN) diagnostic system for a vehicle is presented. In one exemplary implementation, the CAN diagnostic system comprises a plurality of electronic control units (ECUs) of the vehicle that are connected to a high-speed CAN of the vehicle and a dedicated control module of the vehicle that is connected to the CAN and that includes an embedded software application configured to receive a diagnostic request for diagnostic data, in response to receiving the diagnostic request, obtain the diagnostic data by at least one of (i) issuing a request to any of the plurality of ECUs for any specific data available from any of the plurality of ECUs and (ii) interpreting raw data pushed onto the CAN by any of the plurality of ECUs, and generate and output a standardized output based on the obtained diagnostic data.

In some implementations, the embedded software application is configured to issue the request to any of the plurality of ECUs for any specific data available data from any of the plurality of ECUs. In some implementations, the plurality of ECUs are configured to push CAN frames based on raw data onto the CAN, and wherein the embedded software application is configured to decode the CAN frames into scaled engineering values that are included in the diagnostic data. In some implementations, the dedicated control module further includes a diagnostic interface that is configured to connect to an external component and provide the standardized output thereto. In some implementations, the external component is a cloud-based back-end. In some implementations, the external component is a diagnostic tool. In some implementations, the CAN is one of a CAN flexible data rate (FD) network, a CAN extended data-field length (XL) network, or an Automotive Ethernet network. In some implementations, the CAN diagnostic system does not utilize CAN unified diagnostic services (UDS) or CAN keyword protocol (KWP). In some implementations, the dedicated control module is an electronic throttle module (ETM) or a transmission control module (TCM).

According to another example aspect of the invention, a CAN diagnostic method for a vehicle is presented. In one exemplary implementation, the CAN diagnostic method comprises providing a plurality of ECUs of the vehicle that are connected to a high-speed CAN of the vehicle, providing a dedicated control module of the vehicle that is connected to the CAN and that includes an embedded software application, receiving, by the embedded software application of the dedicated control module, a diagnostic request for diagnostic data, in response to receiving the diagnostic request, obtaining, by the embedded software application of the dedicated control module, the diagnostic data by at least one of (i) issuing a request to any of the plurality of ECUs for any specific data available from any of the plurality of ECUs and (ii) interpreting raw data pushed onto the CAN by any of the plurality of ECUs, and generating and outputting, by the embedded software application of the dedicated control module, a standardized output based on the obtained diagnostic data.

In some implementations, the method further comprises issuing, by the embedded software application of the dedicated control module, the request to any of the plurality of ECUs for any specific data available data from any of the plurality of ECUs. In some implementations, the plurality of ECUs are configured to push CAN frames based on raw data onto the CAN, and the method further comprises decoding, by the embedded software application of the dedicated control module, the CAN frames into scaled engineering values that are included in the diagnostic data. In some implementations, the dedicated control module further includes a diagnostic interface that is configured to connect to an external component and provide the standardized output thereto. In some implementations, the external component is a cloud-based back-end. In some implementations, the external component is a diagnostic tool. In some implementations, the CAN is one of a CAN FD network, a CAN XL network, or an Automotive Ethernet network. In some implementations, the CAN diagnostic system does not utilize CAN UDS or CAN KWP. In some implementations, the dedicated control module is an ETM or a TCM.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having a controller area network (CAN) and an example CAN diagnostic system according to the principles of the present application;

FIGS. 2A-2B are functional block diagrams of an example architecture for the CAN diagnostic system according to the principles of the present application; and

FIG. 3 is a flow diagram of an example CAN diagnostic method for a vehicle having a high-speed CAN according to the principles of the present application.

### DESCRIPTION

As previously discussed, conventional controller area network (CAN) diagnostics include CAN Unified Diagnostic Services (UDS) and CAN Keyword Protocol (KWP). These protocols have several disadvantages, including limited speed, flexibility, and scalability. More specifically, these protocols were designed for low-speed communication (i.e., low-speed CAN networks) and are not optimized for high-speed networks such as CAN Flexible Data Rate (FD) or Automotive Ethernet. Thus they cannot handle the amount of data being generated by today's vehicles. Additionally, the CAN databases in these protocols are bespoken for each vehicle model and are not easy to update and decode a signal that was not already predefined. This makes it difficult to diagnose new issues or adapt to changing requirements. Overall, these limitations can lead to slower response times, reduced efficiency, and increased costs. Accordingly, improved CAN diagnostic systems and methods for vehicles having high-speed CAN networks are presented herein.

These techniques utilize high-speed CAN networks (CAN FD, CAN extended data-field length (XL), Automotive Ethernet, etc.), abstract vehicle CAN diagnostic commands, and provide a unified interface for accessing real-time data from various electronic control units (ECUs) on the network. The system comprises a centralized software gateway (SGW) module and a dedicated module (an electronic throttle module (ETM), a transmission control module (TCM), etc.) that is equipped with an embedded software application (an “All Data Application,” or ADA) that acts as a signal abstraction layer and provides a unified interface for accessing real-time diagnostic data from the various ECUs and related systems. The ADA can interpret the raw data to decode CAN frames into scaled engineering values and can also issue requests for any available data from the ECUs. The ADA also generates a standardized output, such as to a cloud-based back-end.

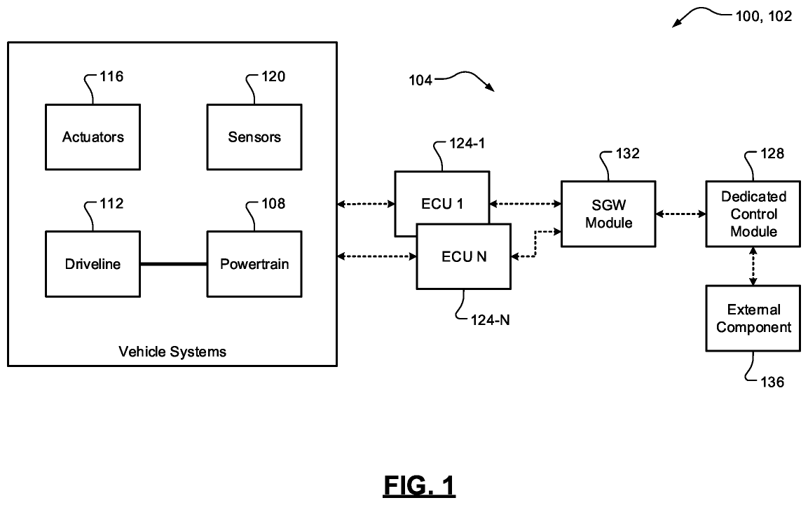

Referring now to FIG. 1, a functional block diagram of a vehicle 100 having a high-speed CAN 102 and an example CAN diagnostic system 104 according to the principles of the present application is illustrated. The vehicle 100 generally comprises a powertrain 108 configured to generate and transfer drive torque to a driveline 112 for vehicle propulsion. The vehicle 100 also includes a plurality of actuators 116 configured to actuate corresponding devices/systems and a plurality of sensors 120 configured to monitor various operating parameters of the vehicle 100. The high-speed CAN 102 (also referred to as “CAN 102”) could be, for example, a CAN-FD, CAN-XL, or Automotive Ethernet network. The CAN diagnostic system 104 includes various components connected on the CAN 102, including a plurality of ECUs 124-1 . . . 124-N (collectively, “plurality of ECUs 124” or “ECUs 124,” where N is an integer greater than one) and a dedicated control module 128. The CAN 102 could also include a software gateway (SGW) module 132 arranged therebetween.

Non-limiting examples of the plurality of ECUs 124 include an engine control module (ECM), an ETM, a TCM, a body control module (BCM), a brake system module (BSM), and an electrified vehicle control unit (EVCU) or hybrid control processor (HCP). It will be appreciated that these are merely examples of the ECUs 124, which also depend on the configuration of the vehicle 100 or its powertrain 108 (i.e., conventional engine-only vs. hybrid vs. electric only). The dedicated control module 128 could be, for example, only of the plurality of ECUs 124. For example only, the dedicated control module 128 could be the ETM or the TCM as these modules typically have diagnostic interfaces already integrated therein. The dedicated control module 128 could be, for example, configured for communication with an external component 136 (a cloud-based back-end, a diagnostic tool, etc.). The CAN diagnostic system 104 of the present application includes the plurality of ECUs 124 and the dedicated control module 128, which will now be discussed in greater detail below.

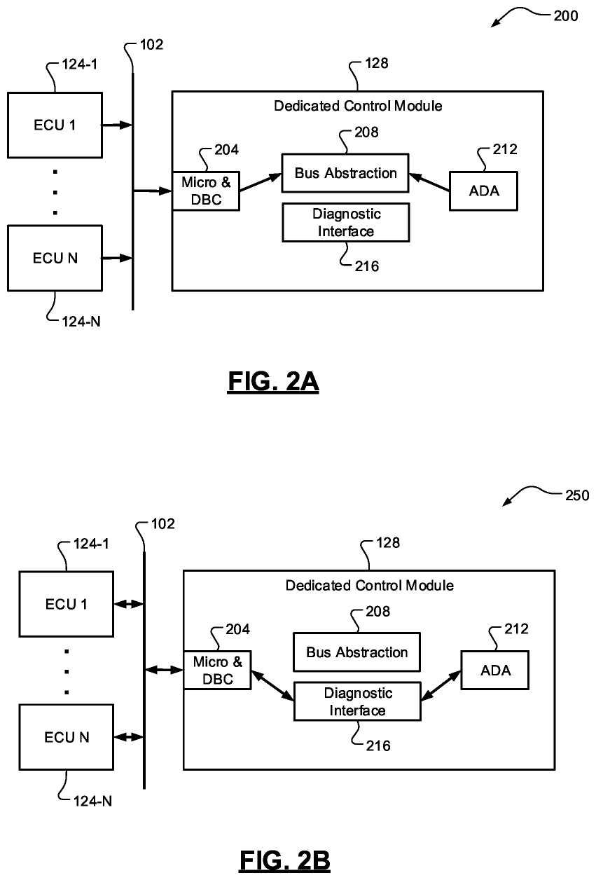

Referring now to FIGS. 2A-2B and with continued reference to FIG. 1, functional block diagrams of example architectures 200, 250 of the CAN diagnostic system 104 according to the principles of the present application are illustrated. It will be appreciated that these architectures 200, 250 are structurally the same but illustrate different communication and processes being performed by the respective components therein. The dedicated control module 128 is connected to the CAN 102 (also referred to as “CAN bus 102”) along with the plurality of ECUs 124. The dedicated control module 128 includes a microcontroller and database component (micro & DBC) 204 that handles communications via the dedicated control module 128 and the CAN 102. The dedicated control module 128 also includes a bus abstraction component 208, the embedded software or ADA 212, and a diagnostic interface 216. While not shown, it will be appreciated that the diagnostic interface 216 could be in communication with the external component 136.

In a first state or configuration (architecture 200), the plurality of ECUs 124 are pushing raw data and/or CAN frames formed of the raw data onto the CAN bus 102. For example, the plurality of ECUs 124 may be configured to push some data that is intended or design to be utilized by the particular vehicle application as CAN frames, while the plurality of ECUs 124 may also be configured to push other raw data onto the CAN bus 102 that is not intended/designed for a particular use. On another end of the CAN bus 102, the microcontroller and DBC 204 receives or pulls the raw data and/or CAN frames off of the CAN bus 102 and the bus abstraction block 208 determines, in conjunction with the ADA 212, specific values (e.g., scaled engineering values) based on the received/pulled data. This could include, for example only, speeds/temperatures/pressures of specific components of the vehicle 100 and the like. In this first state or configuration (architecture 200), the diagnostic interface 216 is not being utilized as there are no diagnostic functions being performed.

In a second state or configuration (architecture 250), however, the diagnostic interface 216 is being utilized. More specifically, in response to a diagnostic request, the ADA 212 is configured to provide requests for specific raw data and/or CAN frames from any of the plurality of ECUs 124 via the CAN bus 102. These request(s) from the ADA 212 are provided to the microcontroller and DBC 204 via the diagnostic interface 216, which then sends the request(s) to the respective ECUs 124 via the CAN bus. This allows the ADA 212 to retrieve specific raw data, including raw data that was not originally intended or designed to be utilized in the particular vehicle application. However, this raw data could still be useful for diagnostic purposes, particularly in the future after the vehicle 100 has been launched/released. In some cases, the diagnostic interface 216 is configured to provide some or all of the retrieved raw data and/or CAN frames to the external component 132 (a cloud-based back-end, a diagnostic tool, etc.).

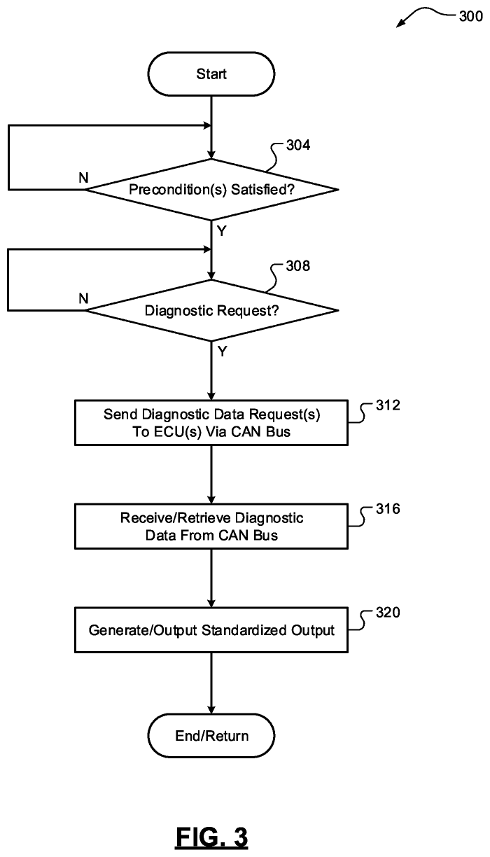

Referring now to FIG. 3, a flow diagram of an example CAN diagnostic method 300 for a vehicle having a high-speed CAN according to the principles of the present application is illustrated. While the vehicle 100 and its components are specifically referenced for illustrative/descriptive purposes, it will be appreciated that the method 300 could be applicable to any suitably configured vehicle having a high-speed CAN. The method 300 begins at 304. At 304, an optional check for whether a set of preconditions have been satisfied could be performed. This could include, for example only, the vehicle 100 being powered-up and running and there being no malfunctions or faults present that would negative impact or otherwise inhibit the operation of the CAN diagnostic techniques of the present application. When false, the method 300 ends or returns to 304. When true, the method 300 continues to 308. At 308, the dedicated control module 128 determines whether a diagnostic request for diagnostic data has been received. When false, the method 300 ends or returns to 308. When true, the method 300 proceeds to 312.

At 312-316, the dedicated control module 128 obtains the diagnostic data by at least one of (i) issuing a request to any of the plurality of ECUs 124 for any specific data available from any of the plurality of ECUs and (ii) interpreting raw data pushed onto the CAN 102 by any of the plurality of ECUs 124. More specifically, at 312 the dedicated control module 128 requests the diagnostic data from the plurality of ECUs 124 and at 316 the dedicated control module 128 receives or retrieves the diagnostic data from the CAN 102. These operations 308-316 could be performed, for example, by the embedded application software (the ADA 212) executing at the dedicated control module 128. At 320, the dedicated control module 128 generates and outputs a standardized output based on the obtained diagnostic data. This could include, for example, converting raw data to scaled engineering values or any other suitable formatting of the diagnostic data into a standardized format for subsequent diagnostic usage. In some cases, the standardized output could be provided, via the diagnostic interface 216, to the external component 136. The method 300 then ends or returns to 304 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A controller area network (CAN) diagnostic system for a vehicle, the CAN diagnostic system comprising:
a plurality of electronic control units (ECUs) of the vehicle that are connected to a high-speed CAN of the vehicle; and
a dedicated control module of the vehicle that is connected to the CAN and that includes an embedded software application configured to:
receive a diagnostic request for diagnostic data;
in response to receiving the diagnostic request, obtain the diagnostic data by at least one of (i) issuing a request to any of the plurality of ECUs for any specific data available from any of the plurality of ECUs and (ii) interpreting raw data pushed onto the CAN by any of the plurality of ECUs; and
generate and output a standardized output based on the obtained diagnostic data.

2. The CAN diagnostic system of claim 1, wherein the embedded software application is configured to issue the request to any of the plurality of ECUs for any specific data available data from any of the plurality of ECUs.

3. The CAN diagnostic system of claim 2, wherein the plurality of ECUs are configured to push CAN frames based on raw data onto the CAN, and wherein the embedded software application is configured to decode the CAN frames into scaled engineering values that are included in the diagnostic data.

4. The CAN diagnostic system of claim 1, wherein the dedicated control module further includes a diagnostic interface that is configured to connect to an external component and provide the standardized output thereto.

5. The CAN diagnostic system of claim 4, wherein the external component is a cloud-based back-end.

6. The CAN diagnostic system of claim 4, wherein the external component is a diagnostic tool.

7. The CAN diagnostic system of claim 1, wherein the CAN is one of a CAN flexible data rate (FD) network, a CAN extended data-field length (XL) network, or an Automotive Ethernet network.

8. The CAN diagnostic system of claim 7, wherein the CAN diagnostic system does not utilize CAN unified diagnostic services (UDS) or CAN keyword protocol (KWP).

9. The CAN diagnostic system of claim 1, wherein the dedicated control module is an electronic throttle module (ETM) or a transmission control module (TCM).

10. A controller area network (CAN) diagnostic method for a vehicle, the CAN diagnostic method comprising:
providing a plurality of electronic control units (ECUs) of the vehicle that are connected to a high-speed CAN of the vehicle;
providing a dedicated control module of the vehicle that is connected to the CAN and that includes an embedded software application;
receiving, by the embedded software application of the dedicated control module, a diagnostic request for diagnostic data;
in response to receiving the diagnostic request, obtaining, by the embedded software application of the dedicated control module, the diagnostic data by at least one of (i) issuing a request to any of the plurality of ECUs for any specific data available from any of the plurality of ECUs and (ii) interpreting raw data pushed onto the CAN by any of the plurality of ECUs; and
generating and outputting, by the embedded software application of the dedicated control module, a standardized output based on the obtained diagnostic data.

11. The CAN diagnostic method of claim 10, further comprising issuing, by the embedded software application of the dedicated control module, the request to any of the plurality of ECUs for any specific data available data from any of the plurality of ECUs.

12. The CAN diagnostic method of claim 11, wherein the plurality of ECUs are configured to push CAN frames based on raw data onto the CAN, and further comprising decoding, by the embedded software application of the dedicated control module, the CAN frames into scaled engineering values that are included in the diagnostic data.

13. The CAN diagnostic method of claim 10, wherein the dedicated control module further includes a diagnostic interface that is configured to connect to an external component and provide the standardized output thereto.

14. The CAN diagnostic method of claim 13, wherein the external component is a cloud-based back-end.

15. The CAN diagnostic method of claim 13, wherein the external component is a diagnostic tool.

16. The CAN diagnostic method of claim 10, wherein the CAN is one of a CAN flexible data rate (FD) network, a CAN extended data-field length (XL) network, or an Automotive Ethernet network.

17. The CAN diagnostic method of claim 16, wherein the CAN diagnostic system does not utilize CAN unified diagnostic services (UDS) or CAN keyword protocol (KWP).

18. The CAN diagnostic method of claim 10, wherein the dedicated control module is an electronic throttle module (ETM) or a transmission control module (TCM).
